(19) United States
(12) Patent Application Publication
(10) Pub. No.: US 2010/0251645 A1
(43) Pub. Date: Oct. 7, 2010

(54) CONCRETE FORM BUCKS

(75) Inventor: Michel Joseph Rene Philippe, Hammond (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Phil -Insul Corporation, Kingston, ON (CA)

(21) Appl. No.: 12/740,258

(22) PCT Filed: Oct. 29, 2008
(86) PCT No.: PCT/CA08/01904

§ 371 Date: Apr. 28, 2010

(30) Foreign Application Priority Data
Oct. 30, 2007 (CA) 2608801

(51) Int. Cl. E06B 1/04; B28B 7/22

(52) U.S. Cl. 52/215; 249/98

(57) ABSTRACT

A buck for use with concrete form systems, such as insulated concrete forms and the like, is provided. The buck is particularly suitable for an opening in an insulated concrete form and comprises a main section having first and second ends, the first end for attaching to a first panel in the insulated concrete form, an angle section having first and second ends, the first end connected to the main section and the second end of the angle section for attaching to a second panel of the insulated concrete form, for providing an angle between the angle section and the main section, wherein at least one of the main section and the angle section is disposed non-perpendicularly from the first panel or second panel. The buck provides and allows for wider openings, such as doors or windows, to facilitate easier entry or passage of materials therethrough, to expand the field of vision, to allow more light entry inside the building, to reduce wind turbulence and noise around the openings, and to increase energy efficiency.

### CROSS REFERENCE TO RELATED APPLICATIONS

This application claims the benefit of priority of Canadian Patent Application No. 2,608,801, filed Oct. 30, 2007, which is incorporated herein by reference.

### FIELD OF THE INVENTION

The present invention relates generally to bucks for providing openings in concrete forms, and more particularly to bucks for use in insulated concrete forms.

### BACKGROUND OF THE INVENTION

Insulated concrete forms (ICFs) are used in the construction of insulated concrete walls in a variety of building applications. In a system of ICFs, a series of opposing panels or pre-assembled block are separated, preferably by a distance equal to the thickness of the desired concrete wall, thus providing a channel, wall or column cavity into which concrete is poured. A typical ICF can comprise a pre-assembled block and/or one or more outside or main panels, and one or more inside or opposing panels across the wall cavity. Each panel usually has an exterior surface and an interior surface. The panels are typically left permanently in place to serve as thermal or acoustic insulation, to provide space for running electrical wiring & plumbing, and as backing for gypsum boards, stucco, brick, or other siding on both the inside or outside of the panels or pre-assembled block.

The panels in an ICF system are often made of foam insulation or some other durable insulating or composite materials (foam, cement, wood chips/saw dust, plastics) or such as expanded polystyrene. Panel sections can be secured together using ties or braces, or can slide together in a lock-and-key, tab-and-slot, dovetail, tongue-and-groove or other interlocking arrangements with respectively interlocking members (see, for example, U.S. Pat. No. 5,428,933, issued Jul. 4, 1995 to Philippe and incorporated herein by reference, which describes flipable, reversible and/or bi-directional panels having an interlocking arrangement therein). The panels can be flat (yielding an even surface of concrete throughout the walls) or shaped, such as in a waffle or grid, where the concrete is thicker in some sections than others within the wall.

Openings in the walls of typical ICF systems are required to provide windows, doors, and other means of passage therethrough. For these openings, bucks are used.

A buck may be one of three types: recessed, protruding, or “channel.” A pressure-treated 2× buck is frequently installed to provide an attachment surface for windows and doors. Alternatively, a water-resistant membrane may be used between wood and ICFs. Some prefabricated plastic and vinyl bucks are now available and becoming widely used. Sizing a buck is key to efficient installation of windows and doors. Whether the windows have “masonry style” window frames or frames with nailing flanges, the rough opening should be sized appropriately to accommodate the actual windows size.

Bucks are known in the art, such as in U.S. Pat. No. 6,530,185, to Scott et al., and elsewhere. The bucks known in the art tend to be squared off for standard installation in typical openings in the ICF panels, such as windows and doors. Standard, square or rectangular bucks have their disadvantages. Typically, square and rectangular bucks contribute to an increased wall thickness because of the insulation added on both sides of the concrete wall in an ICF. They have limited viewing area or permit only a restricted passageway therethrough, which may hamper building evacuation procedures in emergency situations or allow reduced sunlight, which can increase energy costs, as well as air turbulence and whispering noise. Further, the relative uniformity of such bucks is often not esthetically pleasing, particularly when artistic merits of the structure in question is to be considered.

It is, therefore, desirable to provide a more versatile, safe and visually appealing buck for openings, such as doors and windows, in concrete form systems, such as ICF systems.

### SUMMARY OF THE INVENTION

It is an object of the present invention to obviate or mitigate at least one disadvantage of previous bucks used in construction materials, such as concrete forms and, in particular, insulated concrete forms (ICE) and systems thereof.

In a first aspect, the present invention provides a buck for an opening in a concrete form, the buck comprising: a main section having first and second ends, the first end attachable to a first panel in the concrete form; and an angle section having first and second ends, the first end connected to the second end of the main section and the second end of the angle section attachable to a second panel of the concrete form, for providing an angle between the angle section and the main section. The buck can be used with conventional concrete forms and, in particular, ICF, for example.

To provide an angled buck, at least one of the main section and the angle section can be disposed non-perpendicularly from the first panel or second panel. Unlike the straight-edged bucks which are currently used and known in the art and which generally lack aesthetic or practical functionality, an angled buck in accordance with the present invention is particularly advantageous. The bucks are particularly suited to door and/or window openings in concrete forms and the panels thereof. The present bucks can provide a wider opening (such as greater than 90° from the axis of the walls of the concrete system), making it easier to open doors/windows which are installed in the concrete form.

The bucks can be manufactured with a pre-fabricated angle therein, such that the main section and angle section are integrated within the buck. Alternatively, the buck can be modular with main and angle sections pieced together as required in the concrete form system. The bucks can comprise one or more adjustable or removable members which render the buck more flexible in a wide assortment of applications. The member can connect to the second end of the main section and the first end of the angle section, for adjusting and maintaining an angle between the main section and the angle section of the buck. Ideally, the angle can be greater or less than 180° to provide wider or narrower openings as required. Because they are adjustable, the bucks can accommodate openings of different dimensions as needed. The adjustability of the bucks allows for an easier insertion into openings in the ICF system and, ultimately, can save time and money. Alternatively, the buck member can be integral to the block or panel (i.e., prepared in a pre-fabricated mold).

In addition, a buck in accordance with the present invention can be used with panels of different lengths, shapes and sizes, such as ICF panels known in the art and, particularly, those which are flipable, reversible and have connecting means thereon (such as those having alternating projections or recesses, tongue-and-groove or dovetailing designs). The bucks may also be used within a traditional wood or metal concrete forming systems. The panels can be directly opposing or offset from each other.

In another aspect of the present invention there is provided a buck stop. The buck stop is ideal for forming openings within the ICF concrete wall. The buck stop typically comprises a member for contacting with concrete in a channel between two opposing panels of the concrete form, and a removable projection for connecting to the member, wherein the projection is removable after concrete is poured between the two opposing panels.

The buck stop can be similar in construction to the buck used in ICF openings and made of similar materials. The buck stop can also be flipable and reversible. The buck stop is particularly suitable for use as a fire stop in accordance with many building codes, for preventing fire and combustible materials from travelling from one section of a building to another (such as “fire melting”) and traveling or spreading through the foam, vinyl or wood buck materials used to form an ICF wall opening in which window or door frames are fastened. Further, the buck stop can comprise an additional removable member for providing an expansion, construction, or control joint. A buck stop in accordance with the present invention may also be used to accommodate and provide a construction or expansion joint, and/or a keyway within concrete forms (e.g., ICFs and the like) such as conventional wood, plastic or steel.

In yet another embodiment of the buck of the present invention, there is provided a buck for forming a chase in a concrete form, such as an ICF, the buck comprising one or more members for attaching to one or more panels in the concrete form, wherein the chase is formed from the one or more panels and the one or more members. The buck can be used as a “header” (above doors and/or windows) or a “footer” or “sill” (below doors and/or windows) and can incorporate a similar tongue-and-groove or dovetail arrangement for connection of the buck to the top or bottom of adjoining ICF panels. In this way, the buck can be used to form a chase or channel above doors and windows and for connecting to upper and/or lower portions of the concrete form, such as higher or lower floors of a building, for example. The chase is typically formed from two opposing panels in the concrete form and two of the members. The buck can also provide for additional channels within the chase, if one or more additional members for attaching to either the one or more panels or at least one of the two members, are used. Optionally, a member (such as the member described above) can connected to the buck for adjusting or maintaining an angle of the buck within the two panels. The buck can also be used to seal the opening above or below an opening, protecting the interior of the building from air drafts or rain water leakage while also preventing thermal transfer from the inside or outside through the wall, etc.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a top view of a buck in accordance with the present invention.

FIG. 2 shows a buck of the present invention installed between two panels of an insulated concrete form.

FIG. 3 shows a top perspective view of a window opening incorporating a window and a buck in accordance with the present invention.

FIG. 4 shows one end of the window installation illustrated in FIG. 3

FIG. 5 shows a top perspective view of a door opening incorporating a door and a buck in accordance with the present invention.

FIG. 6 shows a top view of a door opening incorporating a door and a buck in accordance with the present invention.

FIG. 7 shows a buck stop in accordance with the present invention.

FIG. 8 shows an embodiment of a chase using a buck in accordance with the present invention, having two vertical dividers and one horizontal divider.

FIG. 9 shows a different embodiment of the chase of FIG. 8, with one vertical divider.

FIG. 10 shows a different embodiment of the chase of FIG. 8, without a divider.

FIG. 11 shows an exemplary angled header buck in accordance with one aspect of the present invention.

FIG. 12 shows an exemplary installation of the angled header buck of FIG. 11.

### DETAILED DESCRIPTION

Generally, the present invention provides a buck for use with concrete form systems, such as insulated concrete forms (ICF) and the like. More particularly, the present invention provides a buck for an opening in an insulated concrete form, the buck comprising: a main section having first and second ends, the first end attachable to a first panel in the concrete form; and an angle section having first and second ends, the first end connected to the second end of the main section, and the second end of the angle section attachable to a second panel of the concrete form, for providing an angle between the angle section and the main section. Typically, at least one of the main section and the angle section is disposed non-perpendicularly from the first panel or second panel.

A buck in accordance with the present invention can be used in conjunction with any building materials and, in particular, wall construction materials known in the art, such as conventional concrete forms. However, it will be appreciated by the person of ordinary skill in the art that the buck of the present invention is especially suited for ICF and the like. The buck of the present invention can be used for any system requiring an open passageway such as, for example, windows, doors, ventilation systems, or other openings as appropriate. In a particular embodiment, the buck of the present invention is ideally suitable for doors, windows and other openings for viewing therethrough.

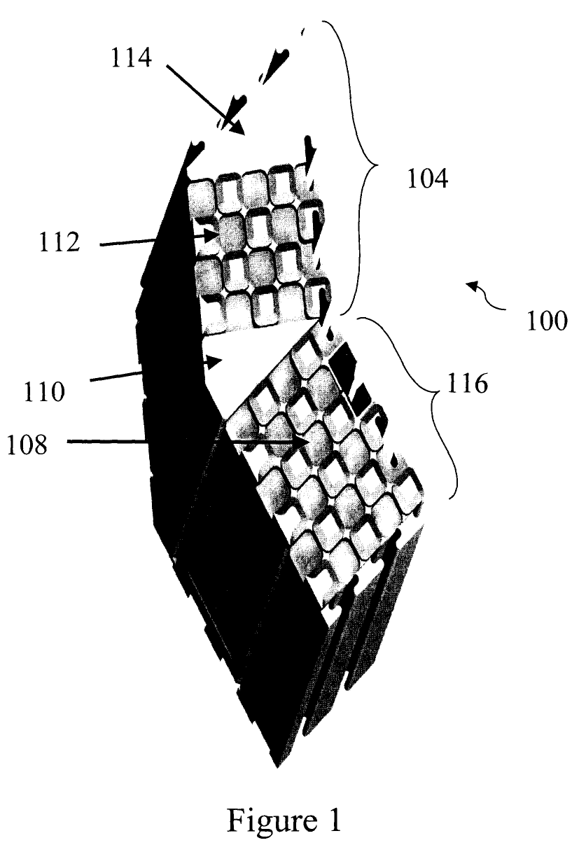

FIG. 1 shows an isolated view of an exemplary buck in accordance with one aspect of the present invention. A typical buck can comprise two sections: a main section 116 which abuts and frames the desired opening in the concrete form; and an angled section 104 which is connected to the main section and angled outwardly from an axis perpendicular to an interior panel. In the context of present invention, “angled outwardly” is intended to cover angles which are greater than 90° from an axis parallel to the interior panel through the opening in the concrete form (i.e., greater than perpendicularly therefrom). In other words, the angle section of the buck is typically angled towards a panel connected to the buck, rather than towards the opening therethrough, to provide a maximum viewing or opening area. Accordingly, the angle between the main section and the angle section can be adjusted such that the overall angle of the buck is not planar, ie., greater or less than 180°. Either of the main section or angle section may be disposed non-perpendicularly from at least one of the panels, such that the outward angle is generated. As would be understood to the skilled person, a buck in accordance with the present invention can have any number of sections to accommodate openings and angles of any desired size for a particular concrete form application.

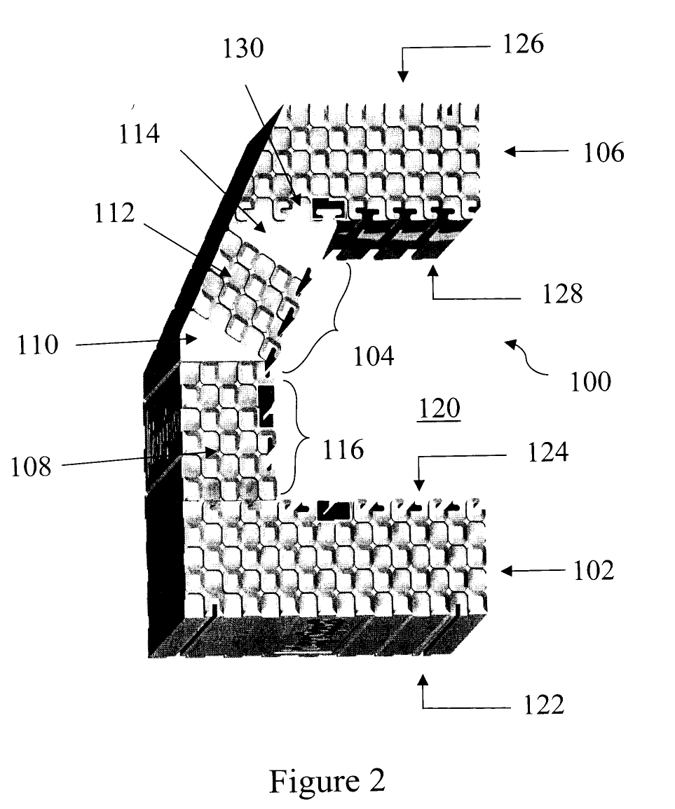

As would be understood by a person of ordinary skill in the art, a buck in accordance with the present invention can be used with an opening of any size or shape in a concrete form. The buck is particularly suited for framing windows and doors formed in concrete form panels; however, any opening, passageway or duct through any section of a concrete form can be envisioned. Ideally, a buck of the present invention provides additional clearance around an opening through a concrete form panel not previously contemplated in the art. The amount of additional clearance can be adjusted depending on the needs of the user. For example, a wedge 110 (as shown in FIG. 2) can be removed or adjusted to provide a more acute or obtuse angle. Alternatively, the wedge can be integral to a pre-fabricated buck. Thus, a buck in accordance with the present invention permits openings greater than 90° from the axis of the concrete form panel up to 180°, and more particularly up to about 120°. In other words, the buck permits an opening which is not necessarily framed exactly 90° from the axis of the concrete form panel. The buck, therefore, need not be perpendicular from that axis, but can extend beyond the perpendicular axis thereof to create a wider opening. This is especially advantageous for widening the view through window openings, for example. With a wider window opening, more light and heat can pass through into the building. Air leakage and whispering wind (and associated noise and turbulence) can also be reduced around these openings because of the angled nature of the bucks. This can produce considerable savings on electricity and heating for the occupants of the building. Esthetically, the wider opening created can enhance the quality and quantity of vision and light for the occupant. Further, the wider opening created by an angled buck in accordance with the present invention can potentially enhance the safety of the occupants in case of an emergency, whereby the occupant has a greater field of vision for determining escape routes and keeping in communication with emergency personnel outside, or for allowing the occupant to monitor the premises outside of the window opening for potential environmental hazards or intrusions. The wider opening may also assist in the easier removal of occupants in case of a fire, for example.

In cases where different openings require different buck angles, the bucks can be made using adjustable or differently-sized molds. This can include manufacturing wedges within the bucks of different angles. As mentioned, the bucks can be made in any shape or size to fit the needs of the user.

A buck in accordance with the present invention can be a single-piece construction, or a modular construction. In the case of a single-piece construction, the angle section and main section are typically pre-fabricated such that the different sections are integral to the buck assembly. For a modular construction, the main section and angle section can come separately and be pieced together as needed for a particular application within the concrete form.

Ideally, durable materials such as plastic, composite or other polymeric materials, wood, cement, or the like. In addition, different components can be added to the buck to extend or adapt the buck in different openings as required. As mentioned, a buck in accordance with the present invention is particularly suitable for use with panels having a locking or tongue-and-groove arrangement, to ensure a secure connection. However, the ends of the bucks can be dovetailed or tongue-and-grooved and attached to panels by sliding inside the panel's dovetail grove(s) or tongue(s)/groove(s) (or other parts of the concrete form, such as the ICF system), with or without using fasteners, glues, or the like. The buck can be any thickness or length depending on the required use, but as mentioned, embodiments of the buck can be adjustable in length to accommodate various dimensions of openings in the concrete form.

The buck can contain a plastic, metal, wood or composite material insert that serves as a nailing strip or stud for fastening a frame in the opening with a suitable fastener directly to the buck or directly through and to the concrete core/wall. In some embodiments of the buck, an additional component could be pre-formed in the buck for ready attachment to a window frame or the like. This can include, but is not limited to, a fastener or tab-slot arrangement, whereby the buck can more readily be connected to the window frame or opposing panels, and/or for adding additional reinforcement to the buck insert within the opening in the concrete form. Fasteners, such as nails, screws or the like, can be added as required to the buck to reinforce the stability and/or strength of the buck in the opening in the panel and within the concrete form once poured. Any additional support, whether pre-fabricated or added to the buck at a job site, may be particularly attractive in buildings which are often vulnerable to environmental conditions such as hurricanes and earthquakes.

Ideally, the bucks of the present invention are flipable and reversible to accommodate any shape or size of opening in the concrete form panel. They can also be used with panels that are flipable and/or reversible. In essence, the bucks have no top or bottom per se, but because of the orientation within an opening and the angle thereof, they may be considered “left-handed” or “right-handed”, depending on the placement of the buck within the opening i.e. angled part either inside, outside or on both sides.

As shown in exemplary buck of FIG. 1, angled section 104 comprises two integral components: angled section body 112 and connector 114. Angled section body 112 can have two ends. One of these ends is connected to connector 114, to allow the buck to attach to an interior face of an outside wall. The other end connects with buck member 110 which connects the other end of the main section 116. Buck member 110 can be wedge-shaped, as shown, to provide a required angle of the buck. Buck member 110 connects angled section 104 with main section 116 to form the complete buck assembly. Buck member 110 can be removed, reshaped, or otherwise altered to provide an appropriate buck angle. One or more buck members may be inserted into a buck as required.

FIG. 2 shows a top view of an exemplary buck of the present invention installed in a portion of an ICF 100. Opposing panels 106 and 102 of the ICF are separated by channel 120 in which concrete is poured to form a wall or another like surface of a structure. Each panel has an interior and exterior surface. The interior surfaces of both panels abuts concrete which is poured into channel 120 to form a wall or similar structure. In the example shown in FIG. 2, panel 102 has two surfaces (an interior surface 124 and an exterior surface 122) and outdoor panel 106 has two surfaces (an interior surface 128 and an exterior surface 126).

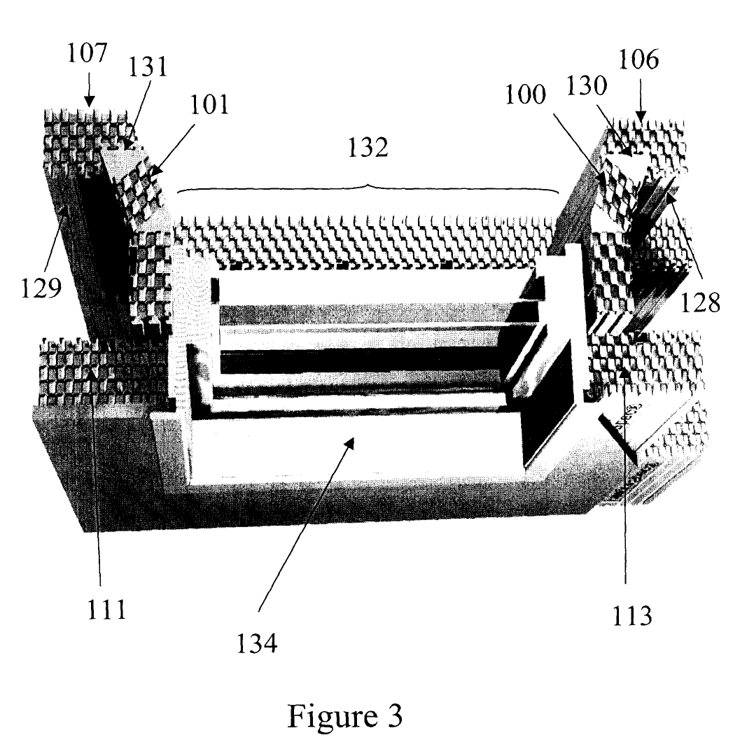

FIG. 3 shows a top perspective view of a window opening incorporating a window and a buck in accordance with one embodiment of the present invention. A window frame 134 is placed into window opening 132 of a typical ICF. As in FIG. 2, bucks 100 and 101 are abut the sides of window frame 134, connecting opposing panels 107/111 and 106/113. Buck edge 130 is connected to interior surface 128 of panel 106, and buck edge 131 connected to interior surface 129 of panel 107. In the embodiment shown, the buck edges have a tongue-and-groove arrangement such that the bucks can be in sliding engagement with the panels at either end of the window opening 132.

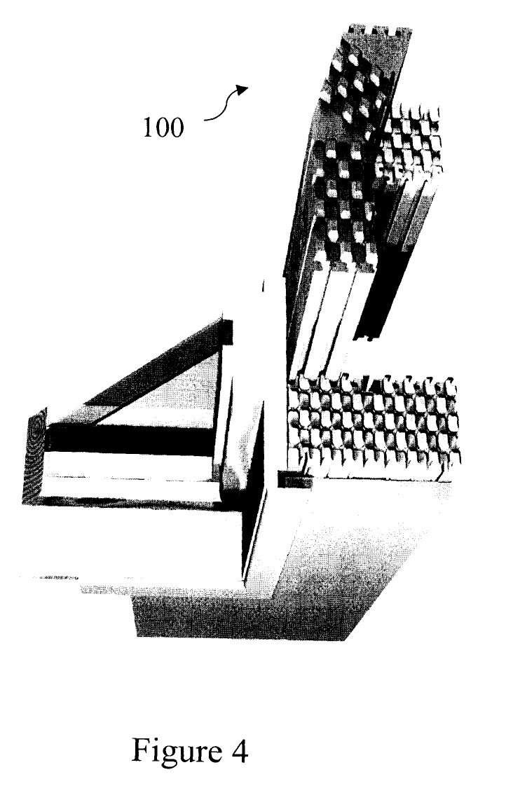

FIG. 4 shows one end in isolation of the window opening arrangement of FIG. 3.

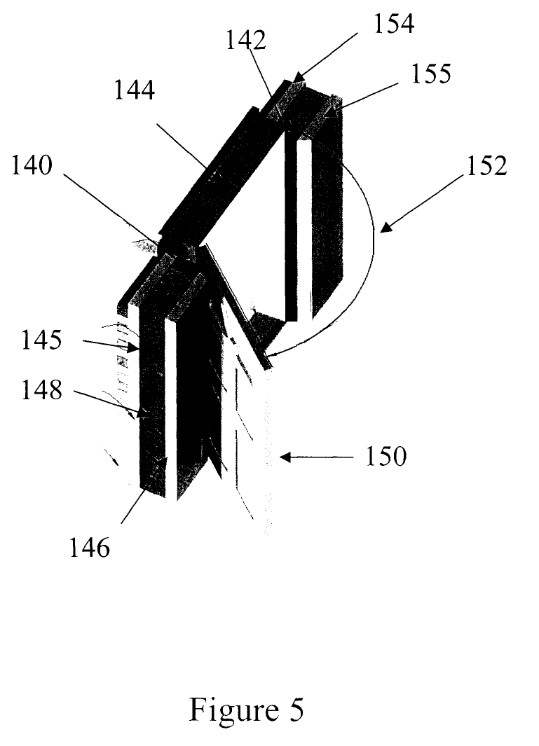

FIG. 5 shows one embodiment of the buck in accordance with the present invention as used for other types of openings, such as doors. Bucks 140, 142 are installed on either side of a door frame 144, between opposing panels 145/146 and 154/155 across a concrete channel 148. Traditional square buck designs, when considering the added thickness of the wall in the presence of concrete and insulation, typically only permit a door to be opened no greater than 90° from the axis of the wall. The ease to open a door in this scenario can be greatly reduced when the door hinges are recessed within the frame. However, and as illustrated in FIG. 5, the angle of the buck permits the door 150 to open at an angle 152 of greater than 90° from the axis of the panels. In the example shown, the door can open approximately 130°. A wider door opening can facilitate the passage of objects (e.g., people, large furniture, appliances, etc.), especially those larger objects which are typically more difficult to transport through door openings. This can also reduce the need to remove the door from the hinges, as would be typically required for the passage of larger items. The wider opening is especially suited for facilitating the passage of people with special needs or disabilities, as the wider opening can permit wheelchairs, larger beds, or equipment to pass therethrough with greater ease.

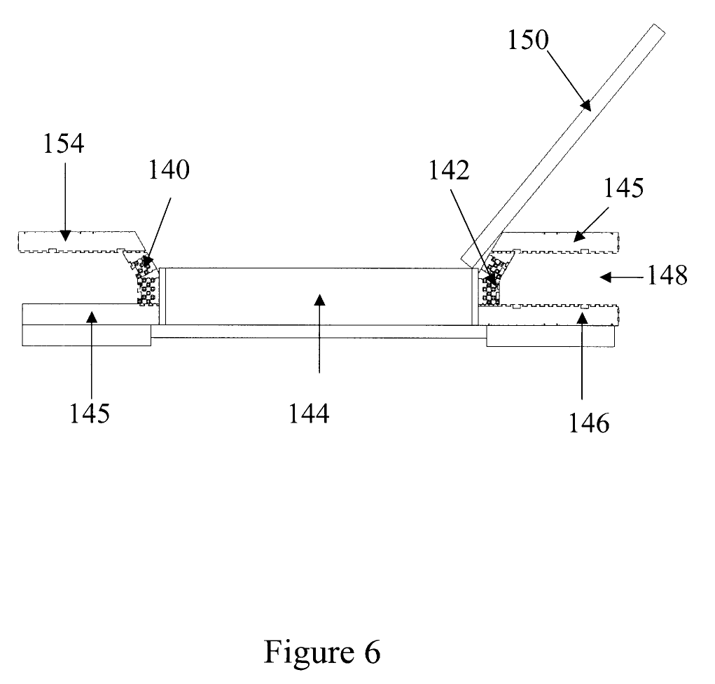

FIG. 6 shows a top view of the door opening of FIG. 5, with the door 150 opened at angle of about 130°.

In another aspect of the present invention there is provided a buck stop. The buck stop is ideal for forming openings within the concrete form wall. The buck stop can be similar in construction to the buck used in concrete form openings and made of similar materials. The buck stop can also be flipable and reversible. The buck stop is particularly suitable for use as a fire stop in accordance with many building codes. Unlike traditional foam bucks stops, the buck stop in accordance with one aspect of the present invention is ideal for preventing fire and combustible materials from traveling from one section of a building to another.

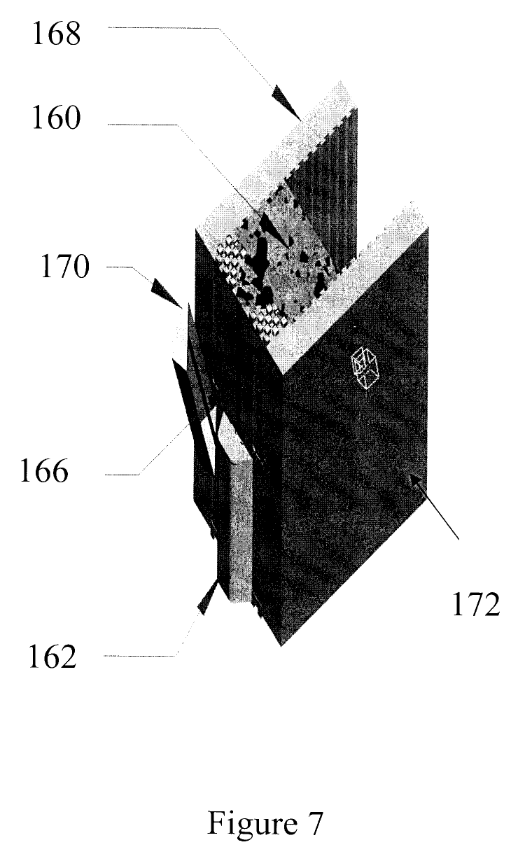

As shown in the exemplary embodiment of FIG. 7, a buck stop in accordance with one aspect of the present invention allows concrete 160 to extend forward towards an opening (such as a window or door, described above, for example). In one example, the buck stop comprises a member for contacting with concrete in a channel between two opposing panels of the concrete form; and a removable projection for connecting to the member, wherein the projection is removable after concrete is poured between the two opposing panels. Once concrete 160 has been poured in the concrete channel and allowed to cure/set, the projected insulated face 162 of the buck stop is cut off and removed 170 from the buck stop. The remaining buck 166 acts as a fire stop by forming a “concrete bridge” or connection between opposing panels 168, 172. In addition, the buck stop can also be reversed and used as a way to form key ways to create construction joints, expansion and/or cold joints when building large scale projects.

In another embodiment of the buck of the present invention, there is provided a header (or a footer or sill) buck which incorporates a similar tongue-and-groove or dovetail arrangement for connection of the buck to the top or bottom of adjoining concrete form panels, such as those in ICF. In this way, the buck can be used above (header) and/or below (footer or sill) doors or windows for connecting to upper and lower portions of the concrete form, such as higher or lower floors of a building, for example. For the sake of clarity, the term “header buck” as used herein is intended to cover any of a header buck, footer buck or sill buck, above and/or below a door and/or a window. The header buck can also be used to seal the opening above or below an opening, protecting the interior of the building from thermal transfer through the concrete, air drafts, etc. The header bucks can be molded, wire cut or prepared on the construction site as needed, and may be in more than one part for connecting portions of different sizes or odd-shaped openings.

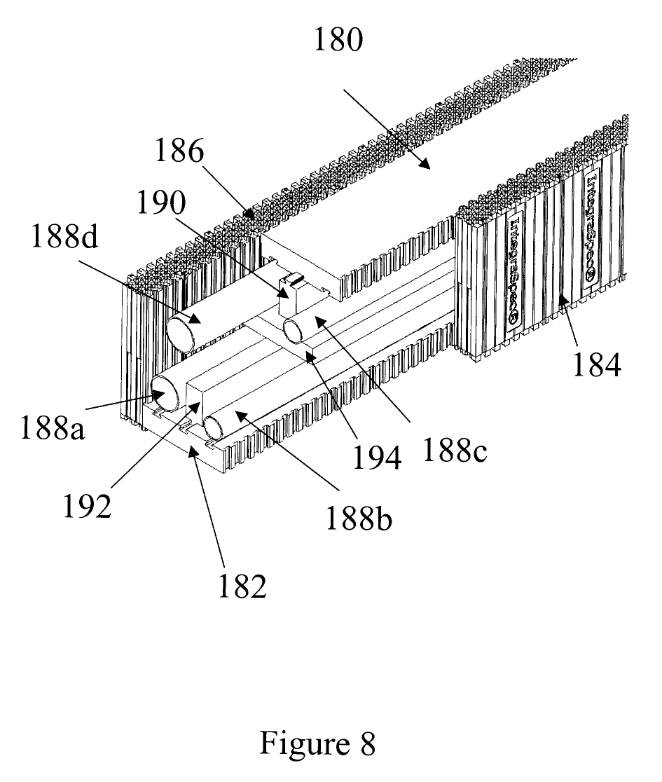

FIGS. 8 to 10 show different embodiments of the header buck described herein. Optimally, the header buck can be made to fit and interlock with concrete form panels, such as ICF panels having a tongue-and-groove or dovetail assembly as described herein. However, the header buck can be attached to the panels in any number of ways. In one example, the buck comprises one or more members for attaching to one or more panels in the concrete form, wherein the chase is formed from the one or more panels and the one or more members. As shown in FIG. 8, the header buck can have two components: a top header buck 180 and a bottom header buck 182. When connected to the opposing panel portions 184, 186, the header bucks form a chase or channel assembly. The chase thus formed can be any size as required, and typically square or rectangular in shape. The chase formed from the header buck can be used to collect and insulate overhead, shallow imbedded or underground utilities (such as plumbing, natural gas or the like, including the exemplary pipes 188a-d as shown), or for running wiring therethrough. The header buck can also be used to form a chase within a concrete form panel, such as an ICF panel assembly for future doors, windows or utility chases which may be added at a later date. The integrated chase reduces the need to manually construct conduits for running utilities or wiring at the construction site. The chase also allows ready access for repairs to the contents thereof, such as pipework, ductwork (ventilation/exhaust) or wires.

As with the window/door buck, the header buck can be made in any size or shape to accommodate a wide variety of concrete forms, such as ICF applications. The header buck can be adjustable, or can be molded into pre-determined sizes. For example, the header buck can be made from 1″ up to 48″+wide, or wider as required for special projects. The header bucks can be made with or without plastic inserts molded therein, and may be installed with or without spacers or webs to reinforce the attachment to the concrete form panels. In the example shown, sliding the top header buck dovetails into the dove tails of panel portions 184, 186, the enclosed chase is sealed and insulated and forms an insulated hollow space. The insulation is especially important for reducing instances of pipe freezing, such as water pipes, or reducing damage caused by heavy equipment at the job site, particularly when filling the chase/channel with concrete, sand, dirt, gravel or other insulating materials.

The chase may also be divided into two or more insulated or non-insulated compartments using members such as dividers. Compartments may be particularly useful in applications such as geothermal heating/cooling, where different liquids in the different pipes circulate at different temperatures. As such, the pipes may need to be at separated to ensure proper temperatures in the individual compartments. Similar to the header bucks, the dividers can be inserted and attached in the buck assembly in any way known in the art. More particularly, the dividers can have dovetailed edges or tongue and groove arrangement for sliding into compatible concrete form panels, such as ICF panels for example. The dividers (in addition to the panels or bucks) can be made of EPS other suitable durable material, including any non-insulating or composite materials (for example, wood, composite wood, composite wood & cement, composite plastics, aerated cement, rubber, or high or low density plastics, etc.).

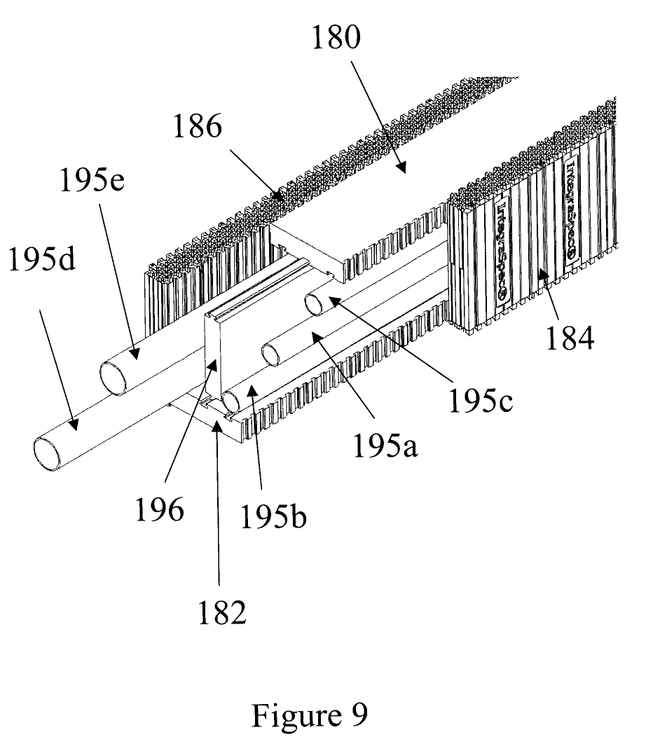

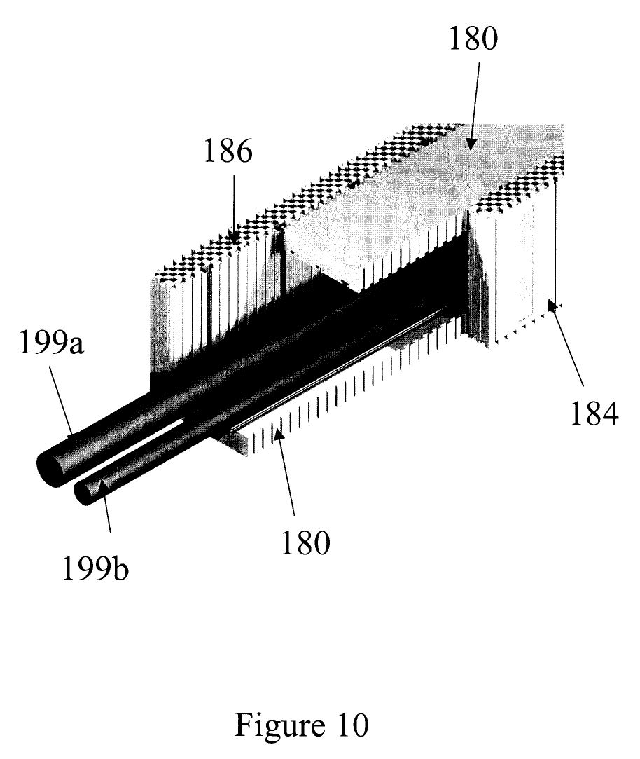

FIG. 8 shows one embodiment of a chase divided into four components with two vertical dividers 190, 192, and one horizontal divider 194. FIG. 9 shows one embodiment of a chase with one vertical divider 196 and piping (195a-e) therein. FIG. 10 shows one embodiment of a chase with piping (199a-b), but without a vertical divider.

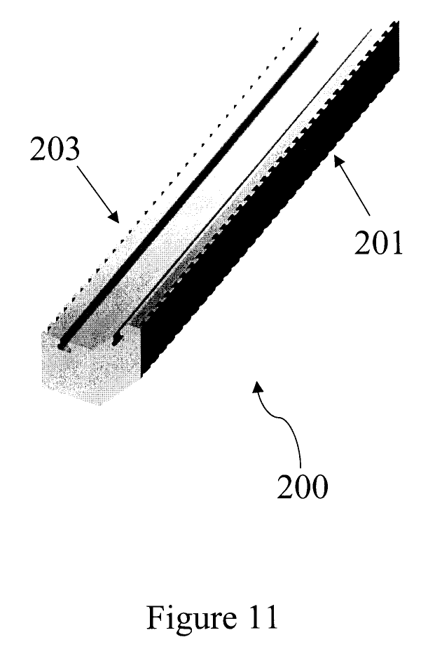

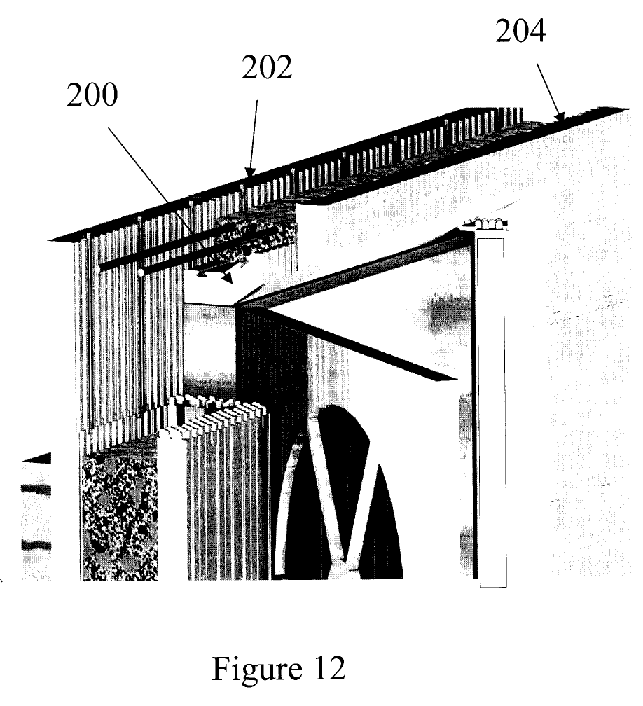

As with the bucks described above, the header or footer bucks in accordance with the present invention need not be straight, but can comprise a member connected to the buck for adjusting or maintaining an angle of the buck between the two panels of the concrete form. Again, the angle of the buck itself can be adjusted within the buck itself, such that the angle is greater or less than 180°. Alternatively, the buck can be pre-fabricated to any desired angle. For example, the buck can be manufactured such that at least a portion of the buck is disposed non-perpendicularly from at least one of the two panels. FIG. 11 shows an exemplary header or footer buck in isolation. As shown, buck 200 is angled to provide additional clearance above an opening, such as a door or window. Buck edges 201, 203 attach to opposing panels in the concrete form. FIG. 12 shows the exemplary buck of FIG. 11 installed to form a chase above a door opening. The buck in this example can be attached to panels 202, 204 using a tongue-and-groove arrangement as described above.

It is also contemplated to have a fastening strip of similar design and material to the buck or concrete form panel. The locking fastening strip can be installed to complement the bucks and headers for future fastening of a door or window frame, or for finishing the trim around openings or at column corners.

The above-described embodiments of the present invention are intended to be examples only. Alterations, modifications and variations may be effected to the particular embodiments by those of skill in the art without departing from the scope of the invention, which is defined solely by the claims appended hereto.

1. A buck for an opening in a concrete form, the buck comprising:
a main section having first and second ends, the first end attachable to a first panel in the concrete form; and
an angle section having first and second ends, the first end connected to the second end of the main section, and the second end of the angle section attachable to a second panel of the concrete form, for providing an angle between the angle section and the main section.

2. The buck of claim 1, wherein at least one of the main section and the angle section is disposed non-perpendicularly from the first panel or second panel.

3. The buck of claim 1, which further comprises a member attachable to the second end of the main section and the first end of the angle section, for adjusting and maintaining the angle between the main section and the angle section of the buck.

4. The buck of claim 3, wherein the member is removable or adjustable.

5. The buck of claim 3, wherein the member is integral to the buck.

6. The buck of claim 1, wherein the concrete form is an insulated concrete form.

7. The buck of claim 6, wherein the first and second panels are flipable or reversible.

8. The buck of claim 1 which is flipable or reversible.

9. The buck of claim 1, wherein the opening is a window or door.

10. A buck for an opening in a concrete form, the buck comprising:
a main section having first and second ends, the first end for attaching to a first panel of the concrete form;
an angle section having first and second ends, the second end of the angle section for attaching to a second panel of the concrete form; and
a member for connecting to the second end of the main section and the first end of the angle section, for adjusting and maintaining an angle between the main section and the angle section of the buck.

11. The buck of claim 10, wherein the angle is greater or less than 180°.

12. The buck of claim 10, wherein the concrete form is an insulated concrete form.

13. A buck stop for a concrete form, comprising:
a member for contacting with concrete in a channel between two opposing panels of the concrete form; and
a removable projection for connecting to the member, wherein the projection is removable after concrete is poured between the two opposing panels.

14. The buck stop of claim 13 further comprising an additional removable member for providing an expansion, construction, or control joint.

15. The buck stop of claim 13, wherein the concrete form is an insulated concrete form.

16. A buck for forming a chase in a concrete form, the buck comprising one or more members for attaching to one or more panels in the concrete form, wherein the chase is formed from the one or more panels and the one or more members.

17. The buck of claim 16, wherein the chase is formed from two panels in the concrete form and the two members.

18. The buck of claim 16, wherein the buck further comprises one or more additional members for attaching to either the one or more panels, or the one or more members, for forming an additional channel within the chase.

19. The buck of claim 16, for use as a header above a door or window opening in the concrete form.

20. The buck of claim 16, for use as a footer below a door or window opening in the concrete form.

21. The buck of claim 16, further comprising a member connected to the buck for adjusting or maintaining an angle of the buck between the two panels.

22. The buck of claim 21, wherein the angle is greater or less than 180°.

23. The buck of claim 16, wherein at least a portion of the buck is disposed non-perpendicularly from at least one of the two panels.

24. The buck of claim 16, wherein the concrete form is an insulated concrete form.
